(19) United States
(12) Patent Application Publication
(10) Pub. No.: US 2014/0313890 A1
(43) Pub. Date: Oct. 23, 2014

(54) PROFILING WI-FI CHANNEL CONGESTION AND INTERFERENCE TO OPTIMIZE CHANNEL SELECTION

(71) Applicants: Curtis Kent Shrote, Zionsville, IN (US); Aaron Reel Bouillet, Noblesville, IN (US)

(72) Inventors: Curtis Kent Shrote, Zionsville, IN (US); Aaron Reel Bouillet, Noblesville, IN (US)

(21) Appl. No.: 14/354,979

(22) PCT Filed: Nov. 1, 2011
(86) PCT No.: PCT/US2011/058720

§ 371 Date: Apr. 29, 2014

(51) Int. Cl. H04W 28/08

(52) U.S. Cl. CPC H04W 28/085
USPC 370/230

(57) ABSTRACT

A method and apparatus are described including receiving, in a wireless receiver, channel interference and congestion window measurements, storing the received channel interference and congestion window measurements, determining a time period of interest, performing data aging responsive to the time period of interest, calculating channel interference and congestion score for an existing channel using data remaining after data aging was performed, calculating channel interference and congestion score for an alternative channel using data remaining after data aging was performed and selecting one of the existing channel and the alternative channel.

### FIELD OF THE INVENTION

The present invention relates to available statistical data from a Wi-Fi access point to select an optimal channel to establish Wi-Fi sessions.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Optimal Wi-Fi channel selection is problematic. Users desire consistent channel throughput while available channel throughput is dynamic over time due to channel interference or throughput consumption due to other users, associated with other access points (APs), being on the same Wi-Fi channel consuming available bandwidth. The users associated with an access point would prefer to operate their AP on a channel that was comparatively free of interference and congestion caused by data traffic from other APs, or at least on a channel that minimizes the interference impact. Interference could be caused by other non-AP, 2.4 Ghz or 5 GHz radiators. Congestion may be caused by other APs on the same channel or by other users consuming bandwidth against the same AP. The present invention deals with the first type of congestion (AP-based).

Wi-Fi channel selection algorithms often incorporate one of the following mechanisms for selecting a Wi-Fi channel.
1) Static channel allocation—In this scenario, the AP utilizes a preselected channel selected at the factory. Preselected channel settings may be overridden manually by the end user. Often, this scenario results in all APs, fielded by an internet service provider (ISP), being assigned the same channel For neighborhoods serviced by a predominate ISP, this often forces the majority of all Wi-Fi traffic onto the same channel since an ISP tends to utilize a limited range of equipment from a limited number of equipment providers to provide services. This results in customer dissatisfaction and could lead to customer service calls. Prior Technicolor as well as other manufacturers' products have used this approach.
2) Random channel selection—In this scenario, the AP randomly selects a channel in the Wi-Fi channel space to provide data throughput. Random channel selection could result in selection of the channel that has the most data traffic as opposed to the channel that is the least used (has the least data traffic). For example, random channel assignment could result in selection of the channel predominately occupied by APs using static channel assignment. Prior Technicolor as well as other manufacturers' products have used this approach.
3) Channel hopping—When interference occurs or the channel becomes saturated with too much traffic, the AP will choose to move to another channel, either immediately or once all existing Wi-Fi sessions associated with the AP have ended. Changing channels, when there are existing Wi-FI sessions associated with the AP in progress, has potential negative consequences. The new channel selection is based on a scan of other channels and a determination of the best channel, with least interference and congestion, is made. Unfortunately, this channel selection method is accomplished based on data which is potentially of the least interest and use to the AP's users. For example, if the AP decides to change channels and all associations are released late in the evening, the new channel selection may prove to be during a time when the interferers are not present or only lightly using the channel. This may be least optimal for the users of the AP, when not frequently done after the first Wi-Fi access initialization. The channel selection may be sub-optimal in that the traffic pattern versus time of day relationship of other channels can be very different from the one currently being used.

### SUMMARY OF THE INVENTION

The invention describes a method to use available statistical data from a Wi-Fi access point to select an optimal channel to establish Wi-Fi sessions.

A method for use in a wireless receiver is described including receiving, in a wireless receiver, channel interference and congestion window measurements, storing the received channel interference and congestion window measurements, determining a time period of interest, performing data aging responsive to the time period of interest, calculating channel interference and congestion score for an existing channel using data remaining after data aging was performed, calculating channel interference and congestion score for an alternative channel using data remaining after data aging was performed and selecting one of the existing channel and the alternative channel.

Also described is an apparatus including a channel interference and congestion window measurements receiving module, a storage means for storing the received channel interference and congestion window measurements, the storage means in communication with the channel interference and congestion window measurements receiving module, a data aging module for determining a time period of interest and performing data aging, the data aging module in communication with the storage means, data in the storage means being updated by invoking the data aging means, an existing channel interference and congestion score calculation module, the existing channel interference and congestion score calculation module in communication with the storage means, an alternative channel interference and congestion score calculation module, the alternative channel interference and congestion score calculation module in communication with the storage means and a channel selection module for selecting one of the existing channel and the alternative channel, the channel selection module in communication with the alternative channel interference and congestion score calculation module and with the existing channel interference and congestion score calculation module.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of a wireless network.

FIG. 2 is a block diagram of an exemplary access point, gateway or wireless node in accordance with the principles of the present invention.

FIG. 3 is a flowchart of an exemplary data aging method in accordance with the principles of the present invention.

FIG. 4 is a flowchart of an exemplary channel interference window measurements method in accordance with the principles of the present invention.

FIG. 5 is a flowchart of an exemplary existing channel interference score calculation method in accordance with the principles of the present invention.

FIG. 6 is a flowchart of an exemplary alternative channel interference score calculation method in accordance with the principles of the present invention.

FIG. 7 is a flowchart of an exemplary channel selection and switching method in accordance with the principles of the present invention.

FIG. 8 is a flowchart of the operation of the profiling method of the present invention.

### DETAILED DESCRIPTION OF THE PREFERRED EMBODIMENTS

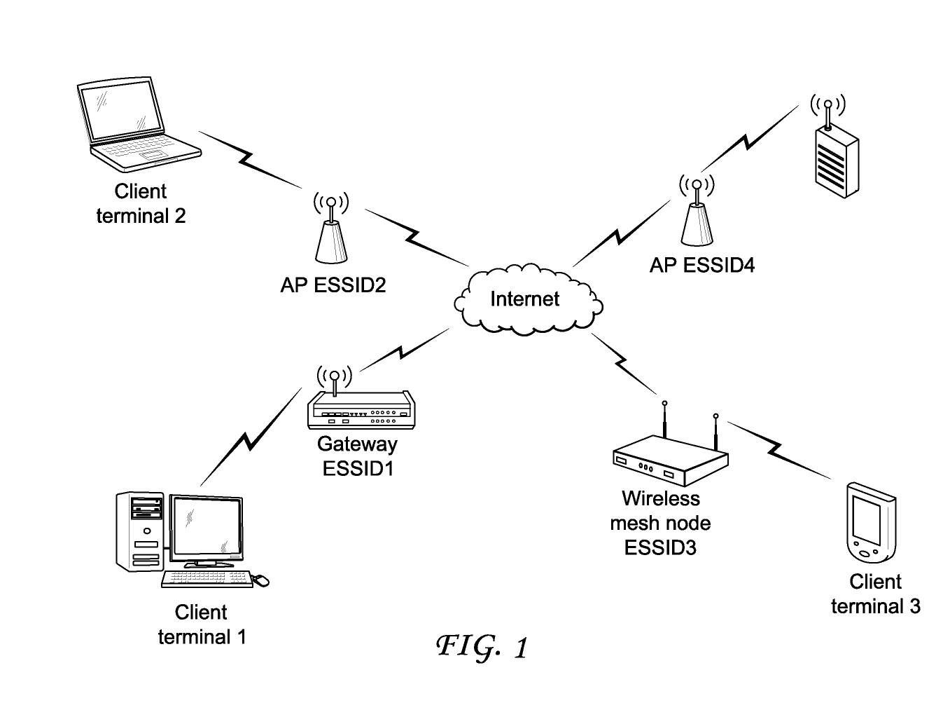

Referring to FIG. 1, which is a schematic diagram of a wireless network. Client terminals (devices) are connected to access points (APs) in order to connect to the Internet. Client terminals may include (but are not limited to) computers, laptops, dual mode smart phones, personal digital assistants (PDAs), iPods, iPads or other tablet type computing devices. Access points (APs) will be used herein to generally include gateways, routers, brouters or other wireless nodes which provide access for one or more client terminals to the internet. As can be seen on FIG. 1, each AP (gateway, wireless node) has a unique ESSID. An ESSID is an electronic service set identifier.

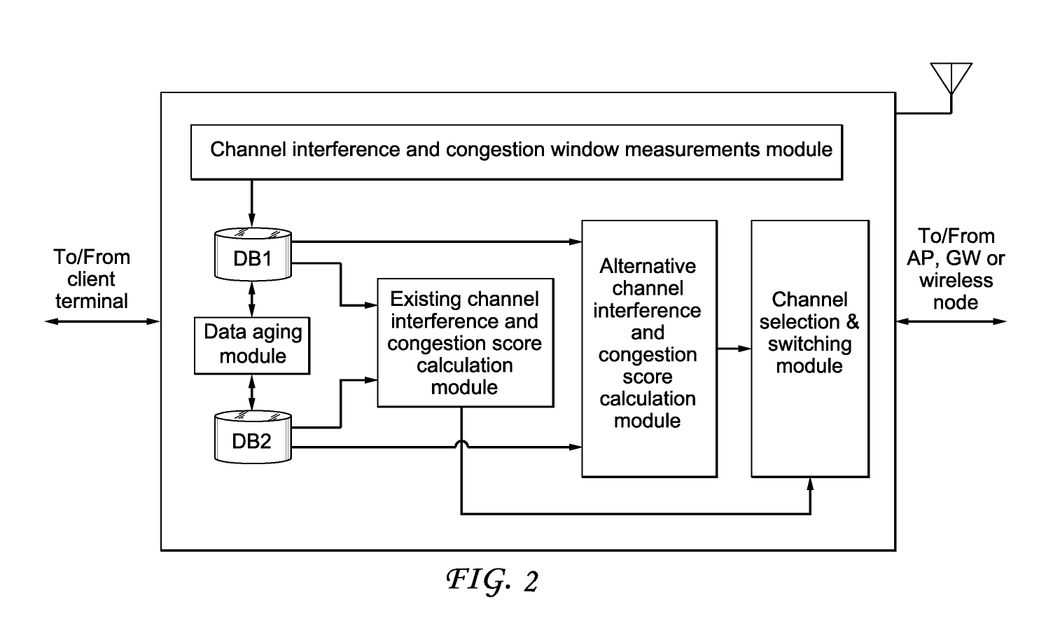

Referring now to FIG. 2, which is a block diagram of an AP. The method of the present invention is performed in an AP. The modules (components) shown are exemplary as are the data bases. There may be more or fewer modules or data bases than are shown. Such increase or decrease in the number of modules or data bases has no effect on the performance of the method and is well within the knowledge of one of ordinary skill in the art. DB 1 holds (stores) the channel interference and congestion windows measurement data. It is updated for time windows by the channel interference windows measurements module, which receives channel interference and congestion window measurements from both its clients and other APs. DB2 holds (stores) the parameterized weights for each of the channels that the AP can use. The initial value of these weights may be set at the factory or set during initial set-up and configuration. DB1 and DB2 are shown as two separate data bases on FIG. 2 but may be a single data base or multiple data bases (as in one for each channel). DB1 and DB2 may, in fact, not be data bases but simply data structures within memory or a storage system. The data aging module inspects data from DB1 and DB2 and if the data is beyond the relevant time period it may be erased or written over. In the alternative, the aged data may be maintained but the weighted parameters in DB2 may be adjusted to indicate a lower weight. A lower weight indicates less relevancy. When new data is collected, the weights should be readjusted to indicate increased relevancy. The existing channel interference score calculation module calculates a channel interference score for the existing channel using the data in DB1 weighted by the parameterized weights of DB2. The alternative channel interference score calculation module calculates a channel interference score for each alternative channel using the data in DB1 weighted by the parameterized weights of DB2. If the data for each alternative channel is incomplete then default data is used for the missing data in order to complete score calculations. The channel selection and switching module inspects the scores for the existing channel and each of the alternative channels and selects a channel based on the scores. The channel selection and switching module switches to the new selected channel if it is different than the current channel

The channel interference and congestion window measurement data that is collected is collected from the Wifi implementation and will aid in the determination of the quality of the Wifi channel selection. The data is for a given channel over a defined time period. Variables may include (but are not limited to) those listed below:
1) Observed SSIDs (ESSIDs) on a channel
2) Mib or equivalent Items: a Mib is a parameter that may be fetched via the SNMP protocol. Alternatively, it could be a parameter fetch via the competing TR-69 protocol.
   a. Dot11RetryCount (RC)
   b. Dot11MultipleRetryCount (MRC)
   c. framesTransmitted (FT)
   d. dot11RTSSuccessCount (RTSSC)
   e. dot11RTSFailureCount (RTSFC)
   f. dot11ACKFailureCount (ACKFC)
   g. dot11ReceivedFragmentCount (RFC)
   h. dot11TransmittedFragmentCount (TFC)
   i. dot11MulticastTransmittedCount (MTC)
   j. dot11FailedCount (FC)

The channel interference window statistical data is collected and aggregated over a period of time (e.g. 5PM-6PM). This period is recommended to be 1 hour or less per time slice in order to more accurately determine usage trends on a channel. The data is stored per channel and per time window for a measurement instance. If newer data is available, older data may be over-written. Time stamps are maintained for each measurement to indicate age of the data. This data is stored in DB1 on FIG. 2.

A parameterized data base of weightings to be applied to the statistics is stored representing the best management method for a given environment. These weights are used to score each statistical measurement as a way of emphasizing the importance of each statistical value. The initial values for the weights may be set at the factory of may be set at initial set-up and configuration. The data aging module may be used to update the weights due to data aging. When new data is collected the weights should be inspected and updated.

A computation (calculation, determination) is made utilizing the weights and the statistical data for the current time period of the current WiFi channel in use. The result is a single score indicating how much channel congestion or interference there is on the existing channel. This is accomplished by the existing channel interference score calculation module. Using the exemplary parameters (variables) given above, the score calculation (computation, determination) may be as follows:

Existing channel interference and congestion score=ω1RC+ω2MRC+ω3FT+ω4RTSSC+ω5RTSFC+ω6ACKFC+ω7 RFC+ω8TFC+ω9MTC+ω10FC

where ωi indicates the weight for the parameter (variable). Weights may be positive or negative. For example RTSSC may be ‘−’ because successfully transmitted packets may be a offset to a certain degree.

The data aging module exists to “age” older data so that prior information does not dominate the channel selection method (process). Older data beyond a certain age may be further weighed such that it has a less favorable score indicating less relevancy. The ability to adjust weights may be a switch (parameter) configured at set-up (initialization).

Data from other WiFi channels for the same time period are extracted from the data base to be used in a vote to determine if a potential better channel exists. Scores are calculated (computed, determined) by the alternative channel interference and congestion score calculation module using data from DB1 and DB2. The same equation (above) is used to calculate (compute, determine) the scores for each of the alternative channels. Scores for alternative channels are calculated from past data for the current time period. If data for a channel does not exist or has been eliminated from the data base due to age, a default data is applied by the alternative channel interference and congestion score calculation module, to provide a score.

The channel selection and switching module compares the scores for the existing channel and all of the alternative channels and the best channel is selected based on the scores. A determination is made if the new proposed (selected) channel is different from the existing channel. This is important for scheduling since it might not be best for some TCP/IP sessions to be interrupted (e.g. streaming video). A channel switch is scheduled so that a minimum of inconvenience is imposed on WiFi users. If the switch does not occur during the valid time window that the scored was completed over, the channel switch is cancelled and new scores are calculated.

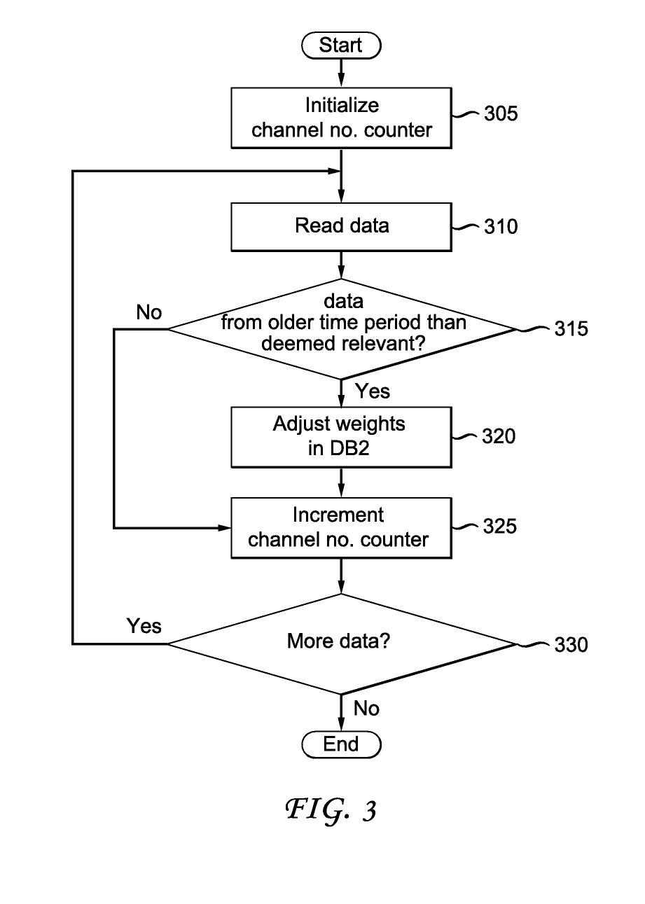

Referring now to FIG. 3, which is a flowchart of an exemplary data aging method in accordance with the principles of the present invention. At 305, a channel number counter is initialized. At 310, data (channel interference and congestion windows measurement data) is read from DB1 for the channel specified in the channel number counter. At 315, a test is performed to determine if the data read (retrieved) from DB1 is from an older time period than deemed relevant. There are many ways in which this can be determined but one exemplary way is to check the time stamp associated with each unit of channel interference and congestion data and compare the time stamp to a time. For example, if the time stamp comparison indicates that the data is more than one hour old. The relevancy of the time period is a configuration parameter that may be set at set-up (initialization). If the data read (retrieved) from DB1 is from an older time period than deemed relevant then at 320 the weights for the data (in DB2) are adjusted to indicate lower relevancy. If the data read (retrieved) from DB1 is not from an older time period than deemed relevant then at 325 the channel number counter is incremented. At 330 a test is performed to determine if there are any more channels to inspect for data aging. If there are any more channels to inspect for data aging then processing proceeds to 310. If there are no more channels to inspect for data aging then this process ends.

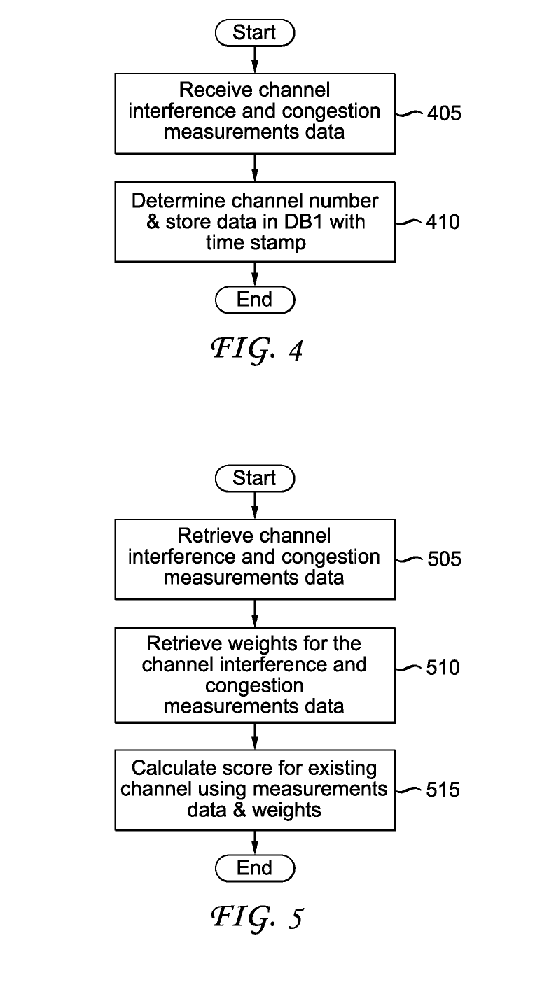

Referring now to FIG. 4, which is a flowchart of an exemplary channel interference and congestion window measurements method in accordance with the principles of the present invention. At 405 data regarding channel interference and congestion measurements is received from a client terminal or another AP. At 410 a determination is made for which channel and the data is stored in DB1.

Referring now to FIG. 5, which is a flowchart of an exemplary existing channel interference and congestion score calculation method in accordance with the principles of the present invention. At 505 channel interference and congestion measurements data (for the time window) is read (retrieved) from DB1. At 510 the parameterized weights for the channel interference and congestion measurements data is read (retrieved) from DB2. At 515, a computation (calculation, determination) is made utilizing the weights and the statistical data (channel interference and congestion measurements data) for the current time period of the current WiFi channel in use. The result is a single score indicating how much channel congestion or interference there is on the existing channel. Using the exemplary parameters (variables) given above, the score calculation (computation, determination) may be as follows:

Existing channel interference and congestion score=ω1RC+ω2MRC+ω3FT+ω4RTSSC+ω5RTSFC+ω6ACKFC+ω7 RFC+ω8TFC+ω9MTC+ω10FC

where ωi indicates the weight for the parameter (variable).

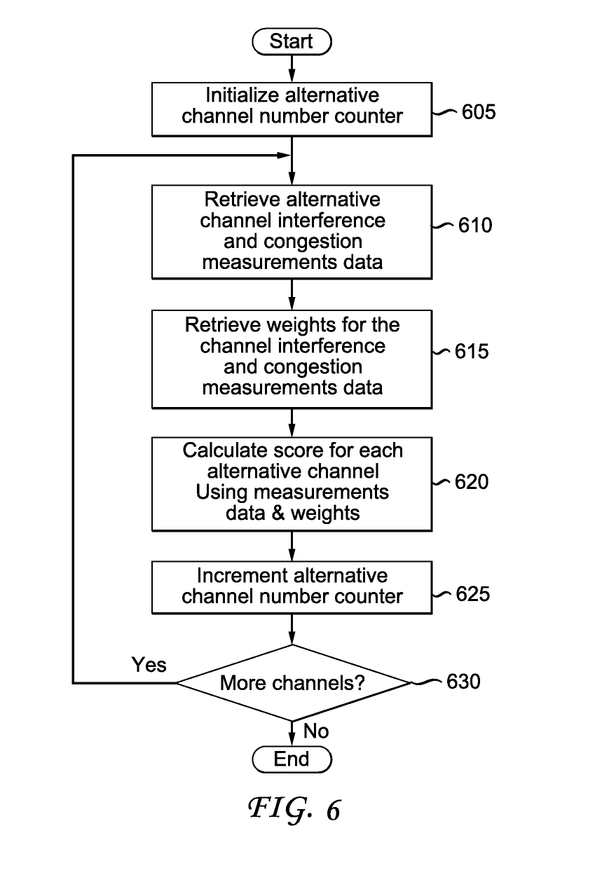

Referring now to FIG. 6, which is a flowchart of an exemplary alternative channel interference and congestion score calculation method in accordance with the principles of the present invention. At 605 an alternative channel number counter is initialized. At 610, the data for the alternative channel specified in the alternative channel number counter is read (retrieved) from DB1. At 615, the parameterized weights for the channel interference and congestion measurements data (for the channel specified in the alternative channel number counter) is read (retrieved) from DB2. At 620, a computation (calculation, determination) is made utilizing the weights and the statistical data (channel interference and congestion measurements data) for the current time period of the WiFi channel specified in the alternative channel number counter. The result is a single score indicating how much channel congestion or interference there is on the alternative channel specified in the alternative channel number counter. Using the exemplary parameters (variables) given above, the score calculation (computation, determination) may be as follows:

Alternative channel interference and congestion score=ω1RC+ω2MRC+ω3FT+ω4RTSSC+ω5RTSFC+ω6ACKFC+ω7 RFC+ω8TFC+ω9MTC+ω10FC

where ωi indicates the weight for the parameter (variable).

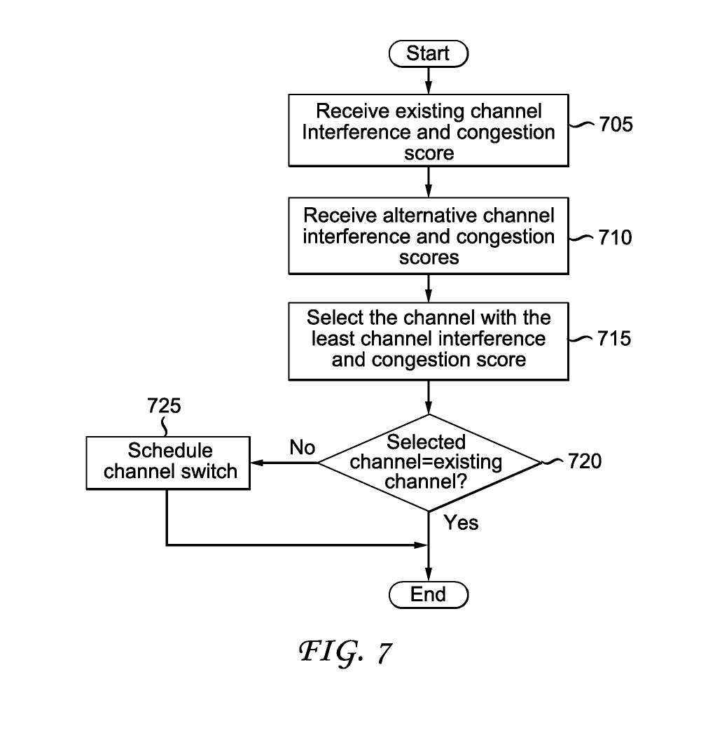

Referring now to FIG. 7, is a flowchart of an exemplary channel selection and switching method in accordance with the principles of the present invention. At 705, the score for the existing channel is read (received, retrieved, accepted). At 710, the scores for each of the alternative channels are (received, retrieved, accepted). At 715, a channel selection is made based on the channel with the largest (highest, best, greatest) score. At 720, a test is performed to determine if the newly selected channel is the same as the existing channel. If the newly selected channel is the same as the existing channel then the process ends. If the newly selected channel is not the same as the existing channel then at 725 a channel switch to the alternative channel) is scheduled.

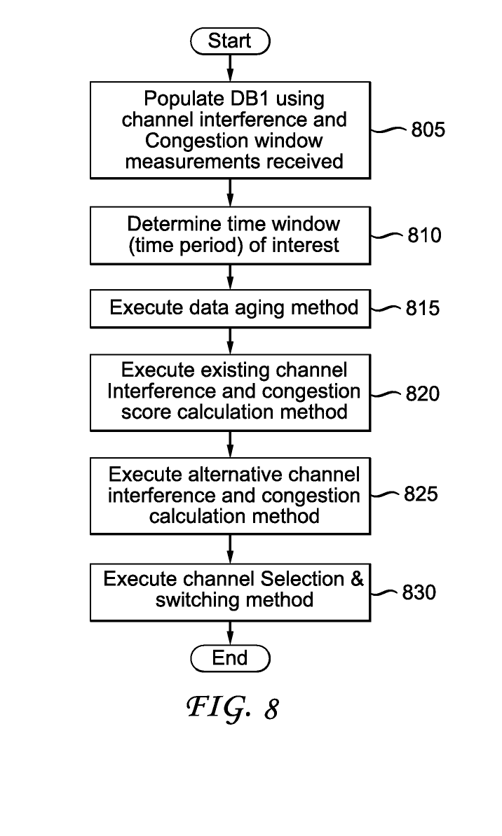

Referring now to FIG. 8, is a flowchart of the operation of the profiling method of the present invention. At 805, the channel interference and congestion window measurements method is sued to populate DB1 with channel interference and congestion measurements data as shown in FIG. 4 and described above. At 810, the time period of interest is determined At 815, the data aging method as shown in FIG. 3 and described above is executed. At 820, the existing channel interference and congestion score calculation method as shown in FIG. 5 and described above is executed. At 825, the alternative channel interference and congestion score calculation method as shown in FIG. 6 and described above is executed. At 830, the channel selection and switching method as shown in FIG. 7 and described above is executed.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for use in a wireless receiver, said method comprising:
receiving, in the wireless receiver, channel interference and congestion window measurements;
storing said received channel interference and congestion window measurements;
determining a time period of interest;
performing data aging on said channel interference and congestion window measurements responsive to said time period of interest;
calculating channel interference and congestion score for an existing channel using data remaining after data aging was performed by applying weights to said remaining existing channel interference and congestion window measurements data;
calculating channel interference and congestion score for an alternative channel using data remaining after data aging was performed by applying weights to said remaining alternative channel interference and congestion window measurements data; and
selecting one of said existing channel and said alternative channel.

2. The method according to claim 1, wherein data aging further comprises:
initializing a channel number counter;
retrieving said stored channel interference and congestion window measurements;
determining if said stored channel interference and congestion window measurements are older than said time period of interest;
adjusting weights corresponding to said stored channel interference and congestion window measurements responsive to said second determination; and
incrementing said channel number counter.

3. The method according to claim 1, further comprising:
retrieving said channel interference and congestion score for said existing channel; and
retrieving weights corresponding to said channel interference and congestion score for said existing channel.

4. The method according to claim 1, further comprising:
initializing an alternative channel number counter;
retrieving said channel interference and congestion score for said alternative channel;
retrieving weights corresponding to said channel interference and congestion score for said alternative channel; and
incrementing said alternative channel number counter.

5. The method according to claim 1, further comprising:
determining if said selected channel is said existing channel; and
scheduling channel switching responsive to said third determination.

6. An apparatus, comprising:
a channel interference and congestion window measurements receiving module;
a storage means for storing received channel interference and congestion window measurements, said storage means in communication with said channel interference and congestion window measurements receiving module;
a data aging module for determining a time period of interest and performing data aging on said channel interference and congestion window measurements, said data aging module in communication with said storage means, data in said storage means being updated by invoking said data aging means;
an existing channel interference and congestion score calculation module, said existing channel interference and congestion score calculation module in communication with said storage means, said existing channel interference and congestion score calculation module calculating a channel interference and congestion score for an existing channel using data remaining after data aging was performed by applying weights to said existing channel interference and congestion window measurements data;
an alternative channel interference and congestion score calculation module, said alternative channel interference and congestion score calculation module in communication with said storage means, said alternative channel interference and congestion score calculation module calculating a channel interference and congestion score for an alternative channel using data remaining after data aging was performed by applying weights to said alternative channel interference and congestion window measurements data; and
a channel selection module for selecting one of said existing channel and said alternative channel, said channel selection module in communication with said alternative channel interference and congestion score calculation module and with said existing channel interference and congestion score calculation module.

7. The apparatus according to claim 6, wherein said apparatus is a wireless receiver.
